(19) United States
(12) Patent Application Publication
(10) Pub. No.: US 2009/0173029 A1
(43) Pub. Date: Jul. 9, 2009

(54) POLYMERIC ACOUSTIC ISOLATOR CLIP FOR ISOLATING WALLBOARD CHANNELS FROM FRAME MEMBER

(76) Inventors: Dennis Albert Socha, Buffalo Grove, IL (US); Randy Paul Mullet, Metairie, LA (US)

Correspondence Address: GREER, BURNS & CRAIN, LTD., 300 SOUTH WACKER DRIVE, SUITE 2500, CHICAGO, IL, 60603, US

(21) Appl. No.: 11/970,352

(22) Filed: Jan. 7, 2008

(51) Int. Cl. E04B 2/44; E04B 1/38; A44B 21/00; F16B 5/02

(52) U.S. Cl. 52/506.08; 24/485; 52/512

(57) ABSTRACT

A clip for use in acoustically isolating a wallboard support channel from a frame member includes a first portion positionable between a first surface of the channel and a frame member, and a second portion positionable in contact with a second surface of the channel. The first and second portions are joined together along a common edge and configured for sandwiching a portion of the channel therebetween and acoustically isolating the channel from the frame member.

### FIELD OF THE INVENTION

This invention relates generally to isolation fasteners used to acoustically isolate items from sources of vibrations, and more particularly to such fasteners used for acoustically isolating wallboard panels from adjacent sound sources, such as nearby living spaces.

A significant issue in housing construction and in multi-family housing construction in particular, is the acoustical isolation between rooms and living units both horizontally and vertically adjacent. Currently, a variety of resilient channels and other sorts of isolation clips are used with varying degrees of cost and effectiveness. It is known to provide a resilient, formed metal channel fastened to a frame member such as wall supports (studs) or floor joists, and to then secure wallboard panels to the channel to isolate the wallboard from the underlying supports. In this scenario, sound transmission through the supports or joists is disrupted, and the space enclosed by the wallboard is somewhat insulated from outside noise. One source of such channels is CEMCO, with the channel sold as RC-1 Resilient Channel. However, in some applications, the use of RC-1 type resilient channel has not provided the desired level of acoustical isolation.

It is also known to provide a clip for use in suspending the RC-1 channel from the underlying supports or joists. More specifically, an RSIC sound isolation clip is produced by PAC International, Inc. (www.pac-intl.com). RSIC clips include a metal bracket provided with a cylindrical resilient pad with a plurality of integral resilient standoffs for engaging the frame member, typically a floor joist or a vertical wall stud. Opposite the pad, the bracket is connected to each leg of a generally “u”-shaped or “hat” channel which defines a space between the pad and the wallboard panel which is secured to the channel. The pad provides the acoustical isolation between the frame member and the wallboard panel.

One drawback of these clips is their relatively high cost, which can approach several dollars each. In addition, the RSIC clip system described above involves a relatively rigid attachment system of the wallboard panel to the frame member. Under the general principles of sound transmission, such rigid attachment generally correlates to a more efficient transmission of sound energy. Thus, such known clip systems are relatively costly for the amount of sound isolation provided.

Sound rated floors are typically evaluated by ASTM Standard # E492 and are rated as to Impact Insulation Class (IIC). The greater the IIC rating, the less impact noise will be transmitted to the area below in the case of floors. Floors may also be rated as to Sound Transmission Class (STC) per ASTM E90. The greater the STC rating, the less airborne sound will be transmitted to the area below. Desired IIC ratings for such wallboard systems are at least 50 and most preferably approaching 60.

Another factor in conventional sound insulation systems is the amount of instruction required for proper installation.

Conventional clip systems are relatively complicated and when improperly installed, the desired levels of sound insulation are not achieved.

Thus, there is a need for an improved system for reducing acoustical transmission of wallboard panels, preferably exceeding the IIC rating of currently available systems. There is also a need for such an improved system which is compatible with conventional channels such as resilient channels. There is also a need for an improved clip for such a system which is relatively inexpensive and relatively easy to install.

### BRIEF DESCRIPTION OF THE INVENTION

The above-listed objects are met or exceeded by the present polymeric isolator clip for supporting wallboard channels relative to a frame member (floor joists, vertical studs or similar framing member) in which a resilient, foam or rubber-like elongate clip includes two halves joined or hinged along a common edge. The two halves define a space in which an edge of a wallboard support channel may be enclosed. An upper half of the clip is provided on an upper surface with insulator formations to further displace the channel from the frame member, especially when a fastener secures the wallboard to the channel. A fastener aperture is found in each of the halves for accommodating a fastener passing through the clip and the support channel for fastening the channel to the frame member. By properly decoupling the wallboard from the frame member or framing member the IIC rating of the system can be improved in the range of 3-5 points. Also, it is believed that the preferred embodiment does not compromise the fire retardant characteristics of the wallboard system.

More specifically, a clip for use in acoustically isolating a wallboard support channel from a frame member includes a first portion positionable between a first surface of the channel and a frame member, and a second portion positionable in contact with a second surface of the channel. The first and second portions are joined together along a common edge and configured for sandwiching a portion of the channel therebetween and acoustically isolating the channel from the frame member.

In another embodiment, a clip for use with a resilient wallboard sound isolation channel is provided and includes a first portion with an exterior surface and an interior surface, a second portion with an exterior surface and an interior surface, the interior surfaces opposing each other. The first and second portions being hingedly joined along a common edge, and configured for sandwiching a portion of the channel therebetween and acoustically isolating the channel from the frame member. In addition, the first portion is provided with a plurality of spaced, generally hemispherical insulation formations projecting generally normally to a longitudinal axis of the clip and configured for engaging the frame member upon the clip sandwiching the channel between said first and second portions.

In still another embodiment, a sound isolation assembly for use in acoustically isolating wallboard panels from an underlying frame member is provided, including at least one elongate resilient channel having at least one attachment edge. A clip for use with the channel in acoustically isolating wallboard panels attached to the channel from the underlying frame member includes a first portion with an exterior surface and an interior surface, a second portion with an exterior surface and an interior surface. The interior surfaces oppose each other and define a space for engagement with the attachment edge. The first and second portions are hingedly joined along a common edge, are configured for sandwiching a portion of the channel therebetween and acoustically isolating the channel from the frame member.

### BRIEF DESCRIPTION OF THE DRAWINGS

FIG. 1 is an exploded top perspective view of an embodiment of the present clip, an associated resilient channel and a mounting fastener;

FIG. 2 is a top elevation view of the clip of FIG. 1, shown in an open position;

FIG. 3 is a top elevation view of an alternate embodiment of the clip of FIG. 1; and

FIG. 4 is a fragmentary side elevation of the present clip assembled with resilient channel to secure a wallboard panel to a frame member.

### DETAILED DESCRIPTION OF THE INVENTION

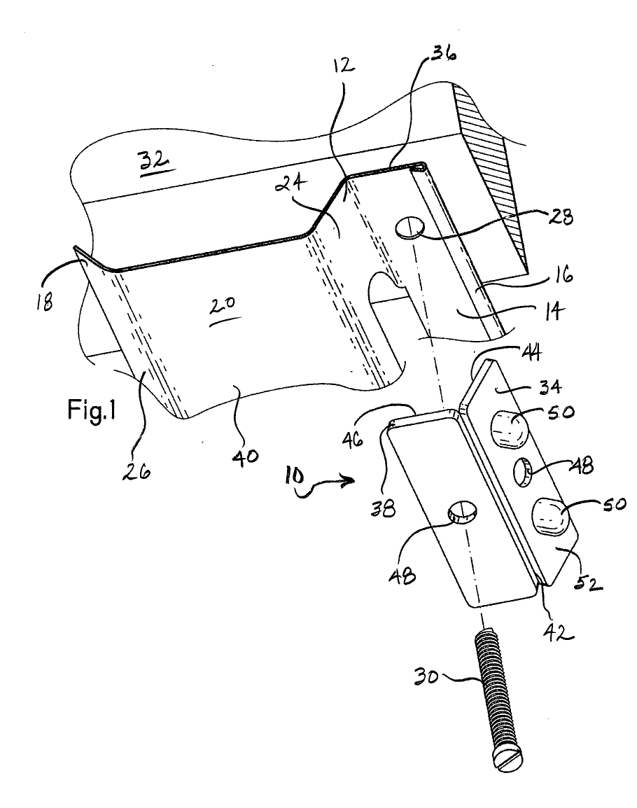

Referring now to FIG. 1, a resilient clip for use in acoustically isolating a wallboard support channel from a frame member is generally designated 10. The clip 10 is shown exploded from a fragment of resilient channel 12 of the type known as RC-1. Such channels are sold by CEMCO, City of Industry California as RC-1 Resilient Channel. While RC-1 type resilient channel (hereinafter resilient channel) is the preferred embodiment and is referred to in the present application, it will be understood that other comparable channels are suitable. The resilient channel 12 is fabricated from hot dipped galvanized steel complying with ASTM C-653 with a G40 coating meeting ASTM A-924 and meets Federal Specification QQ-S-775-D and ASTM-C-645. Manufacturing of the resilient channel 12 is accomplished by roll forming the steel to a shape with an attachment edge or flange 14, here shown with a rolled lip 16 , an opposite free edge 18 and an interim long flat web 20 configured for attachment to a wallboard panel 22 (FIG. 4).

It will be seen that planes defined by the attachment edge 14 and the flat web 20 are displaced from, and generally parallel to each other by inclined panels 24, 26. Further, the attachment edge 14 is preferably provided with at least one mounting point 28 which is preferably a predrilled hole dimensioned for receiving a fastener 30. It will be appreciated that depending on the type of fastener 30, the mounting point 28 may be determined by the installer where the fastener is self tapping.

In the preferred embodiment, the fastener 30 is a threaded screw, and it will be understood that other types of screws or other fasteners are applicable here depending on the structure of a support frame member 32. In this application, “frame member” refers to a floor joist of wood, or metal, a concrete beam or slab or the like, as well as a vertical stud made of wood or metal, or other frame members to which wallboard panels are typically attached as well known in the construction art. The resilient channel 12 partially acoustically isolates the wallboard panel 22 from the frame member 32 by providing an interim, cantilevered connection point which disrupts sound transmissions between the frame member and the wallboard panel.

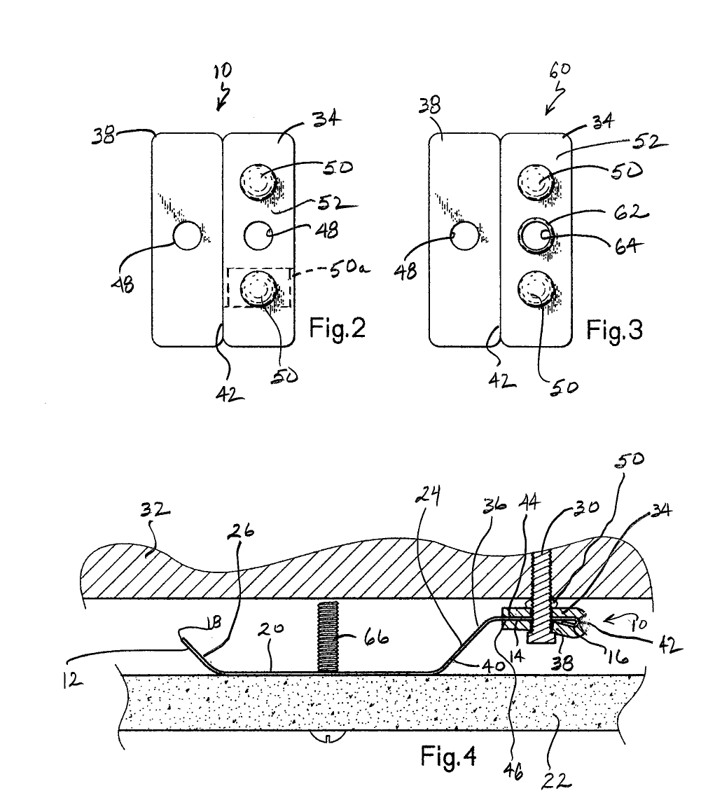

Referring now to FIGS. 1 and 2, the clip 10 is preferably an integral piece of plastic having a first portion 34 configured for positioning between a first, upper exterior surface 36 of the channel 12 and the frame member 32, and a second portion 38 configured for positioning in contact with a second, lower exterior surface 40 of the channel. In this application it will be understood that the orientation of the upper surface 36 and the lower surface 40 of the channel 12 may change to suit the installation application in the event the channel is mounted on a wall or a ceiling, and that the designations “upper ” and “lower” refer to the exemplary orientation depicted in FIG. 4, which is for a ceiling application.

In the preferred embodiment, the first and second portions 34, 38 are generally rectangular when viewed from above (FIG. 2), however other shapes are contemplated. The first and second portions 34, 38 are joined together along a common edge 42 which preferably forms a web-like “living hinge” as is well known in the plastic molding art. Alternately, depending on the material, a row of perforations or other known techniques may be provided to create a hinged edge. Interior surfaces 44, 46 of the clip 10 are configured for sandwiching a portion of the channel 12 therebetween (FIG. 4) and acoustically isolating the channel from the frame member 32.

At least one fastener opening 48 is preferably found on each of the first and second portions 34, 38 for receiving the fastener 30. It will be appreciated that the fastener openings 48 may be pre-drilled holes, pilot holes or otherwise frangible areas in the respective portions which are constructed to facilitate the positioning and engagement of the fastener 30. It will be understood that the fastener openings 48 of the first and second portions 34, 38 are in registry with each other for proper alignment of the clip 10 upon the channel 12, and specifically with the mounting point 28.

Another feature of the clip 10 is at least one insulator formation 50 projecting from, and in the preferred embodiment above an upper surface 52 of the first portion 34. While the formation 50 may be located on the second portion 38 as well, the main purpose of the formation 50 is for enhancing the displacement of the wallboard panel 22 from the frame member 32 (FIG. 4.). As such, upon installation, the formation 50 is located between the clip 10 and the frame member 32.

While the preferred, generally hemispherical configuration of the insulator formation is 50 as depicted, it is contemplated that other shapes, such as rectangular (shown in phantom in FIG. 2 as 50a) are also suitable. It is also contemplated that the formation 50 is configured to be integrated with the upper surface 52 in its shape, and to be less of a distinct formation. Also, it is preferred that a plurality of insulator formations 50 are provided to the first portion 34 in a linear, spaced arrangement along a longitudinal axis of the clip 10, with one such formation on each side of the fastener opening 48. Further, the formations 50 are preferably solid and project normally or perpendicularly from the upper surface 52, and also normally relative to a longitudinal axis of the clip 10. However, other orientations are contemplated as long as the formations engage the frame member 32 upon assembly (FIG. 4).

Referring now to FIG. 3, an alternate embodiment of the clip 10 is generally designated 60, and shared components are designated with identical reference numbers. The main distinction of the clip 60 is that a third insulator formation 62 is provided on the first portion 34. The third formation 62 is similarly dimensioned to the formations 50, but has an inner opening 64 in registry with the fastener opening 48. Thus, in the clip 60, the fastener 30 passes through the second portion 38, the channel 12, the first portion34 and the inner opening 64 prior to engaging the frame member 32. It will be appreciated that the relative dimensions of the third formation 62 and the inner opening 64 may vary with the diameter of the fastener shank employed, as well as the amount of supporting material around the opening required for providing structural integrity to the formation and defining a standoff distance between the frame member 32 and the channel 12.

It is preferred that the clips 10, 60 are made of a resilient or semi-rigid plastic material which provides sound absorbance or dampening. Materials which are durable and resemble rubber are suitable, including but not limited to micro-foamed resilient polymers, as well as foam materials having the required durability and moldability. Polymeric materials which encapsulate air are also suitable due to the decoupling properties of the entrained air. Such materials are used in conventional sound reduction mats. A suitable material is available from Ash Industries, Inc., of Lafayette, La.

Referring now to FIG. 4, upon assembly, the clip 10, 60 is positioned by a user about the attachment edge 14 of the channel 12. Thus, the opposing interior surfaces 44, 46 define a space into which the attachment edge is inserted in sandwich fashion. This may be accomplished by providing the clip 10, 60 in a folded position (FIG. 1) or a flattened position (FIG. 2), where the folding is performed by the user. It is also contemplated that the clip 10, 60 may be provided pre-secured to the channel, as by chemical adhesive, over molding or other known fastening technology. In the latter case, the user merely folds the first portion 34 over the attachment edge 14 to achieve the position shown in FIG. 4.

The fastener 30 is then placed through the openings 48 as well as the mounting point 28. Thus, installation of the present clip 10, 60 is relatively simple compared to conventional clip systems such as the RSIC clips. It will also be seen that the mounting point 28 is dimensioned so that upon tightening of the fastener 30 into the frame member 32, the first and second portions 34, 38 are free of, and do not migrate into the mounting point 28. As is known in the art, the wallboard panel 22 is preferably gypsum wallboard; however other construction panels are contemplated, including but not limited to wood panels and mixtures of gypsum, fibers, rock wool, fiberglass and other construction grade panel materials known in the art. The panel 22 is secured to the flat web 20 of the channel 12.

It has been found that in instances when installers employ wallboard fasteners 66 which are too long, typically over 1.5 inch, upon installation the fastener contacts the frame member 32, thus acoustically “short circuiting” the system and allowing sound to be directly transmitted from the frame member through the wallboard panel 22. The purpose of the insulator formations 50, 62 is to provide a greater spacing between the support frame 32 and the wallboard panel 22 to accommodate a wider range of fastener lengths and to acoustically isolate the fastener 66 from the support frame and the wallboard panel. It will be appreciated that the formations 50, 62 also enhance the decoupling characteristics of the clip 10, 60.

Acoustical isolation is enhanced because the wallboard panel 22 is acoustically decoupled from the support frame 32. Also, the inherent resiliency of the channel 12 assists in dampening sound transmission between the support frame 32 and the wallboard panel 22.

As indicated above, fire performance of such systems is an important design consideration. In the present case, it is believed that in the event of a fire, the clip 10, 60 would melt away, but the physical connection between the fastener 30, the channel and the frame member 32 would remain, maintaining the structural integrity of the system.

While a particular embodiment of the present polymeric-acoustic isolator clip for isolating wallboard support channels from a frame member has been shown and described, it will be appreciated by those skilled in the art that changes and modifications may be made thereto without departing from the invention in its broader aspects and as set forth in the following claims.

What is claimed is:

1. A clip for use in acoustically isolating a wallboard support channel from a frame member, said clip comprising:
a first portion positionable between a first surface of the channel and the frame member;
a second portion positionable in contact with a second surface of the channel member;
said first and second portions joined together along a common edge and configured for sandwiching a portion of the channel therebetween and acoustically isolating the channel from the frame member.

2. The clip of claim 1 wherein said first and second portions each have at least one fastener opening in registry with a corresponding opening on the other of said first and second portions such that a fastener securing the channel to the frame member passes through said corresponding fastener openings.

3. The clip of claim 2 wherein the support channel has at least one mounting point and the fastener passes through said fastener openings and through the mounting point.

4. The clip of claim 1 wherein the support channel has at least one mounting point and, upon assembly, said first and second portions are free of the mounting point.

5. The clip of claim 1 wherein said common edge is integral to said first and second portions, and hingedly connects said portions to each other.

6. The clip of claim 1 wherein at least said first portion is provided with at least one insulator formation projecting above an upper surface of said first portion.

7. The clip of claim 6 wherein said at least one insulator formation is generally hemispherical.

8. The clip of claim 6 further including a pair of said insulator formations axially spaced along said clip.

9. The clip of claim 6 further including a supplemental insulator formation in registry with said fastener openings.

10. The clip of claim 1 wherein said clip is made of resilient plastic.

11. A clip for use with resilient wallboard sound isolation channel, comprising:
a first portion with an exterior surface and an interior surface;
a second portion with an exterior surface and an interior surface;
said interior surfaces opposing each other; and
said first and second portions being hingedly joined along a common edge, and configured for sandwiching a portion of the channel therebetween and acoustically isolating the channel from the frame member;
said first portion being provided on said exterior surface with a plurality of spaced, generally hemispherical insulator formations projecting generally normally to a longitudinal axis of said clip and configured for engaging the frame member upon said clip sandwiching the channel between said first and second portions.

12. The clip of claim 11 wherein said first and second portions each have at least one fastener opening in registry with a corresponding openings on the other of said first and second portions such that a fastener securing the channel to the frame member passes through said corresponding fastener openings.

13. The clip of claim 11 further including a pair of said insulator formations axially spaced along said clip.

14. The clip of claim 11 wherein said first and second portions are each provided with a fastener opening, said respective fastener openings of said first and second portion being in registry with each other, and further including a supplemental insulator formation in registry with said fastener openings.

15. A sound isolation assembly for use in acoustically isolating wallboard panels from an underlying frame member, comprising:
at least one elongate resilient channel having at least one attachment edge;
a clip for use with said channel in acoustically isolating wallboard panels attached to said channel from the underlying frame member, includes a first portion with an exterior surface and an interior surface, a second portion with an exterior surface and an interior surface;
said interior surfaces opposing each other and defining a space for engagement with said attachment edge; and
said first and second portions being hingedly joined along a common edge, and configured for sandwiching a portion of the channel therebetween and acoustically isolating the channel from the frame member.

16. The assembly of claim 15 wherein said channel has one attachment edge configured for attachment to the frame member, a free edge opposite said attachment edge, and a portion between said edges configured for attachment to the wallboard panel.

17. The assembly of claim 15 wherein said first portion is provided with a plurality of spaced insulator formations projecting generally normally to a longitudinal axis of said clip and configured for engaging the frame member upon said clip sandwiching said channel between said first and second portions.
